(19) United States
(12) Patent Application Publication
(10) Pub. No.: US 2013/0058507 A1
(43) Pub. Date: Mar. 7, 2013

(54) METHOD FOR TRANSFERRING DATA TO A MUSICAL SIGNAL PROCESSOR

(71) Applicants: Lars ARKNÆS-PEDERSEN, Viby J. (DK); Henrik JENSEN, Lystrup (DK); Tore Lynggaard MOGENSEN, Hojbjier (DK); Jens Peter KARGO, Skanderborg (DK); Peter Rosendal OVERGAARD, Ronde (DK)

(72) Inventors: Lars ARKNÆS-PEDERSEN, Viby J. (DK); Henrik JENSEN, Lystrup (DK); Tore Lynggaard MOGENSEN, Hojbjier (DK); Jens Peter KARGO, Skanderborg (DK); Peter Rosendal OVERGAARD, Ronde (DK)

(73) Assignee: THE TC GROUP A/S, Risskov (DK)

(21) Appl. No.: 13/600,370

(22) Filed: Aug. 31, 2012

Related U.S. Application Data
(60) Provisional application No. 61/529,616, filed on Aug. 31, 2011.

(30) Foreign Application Priority Data
Aug. 31, 2011 (DK) PA 2011 00655

(51) Int. Cl. G10H 3/18; H04R 3/00

(52) U.S. Cl. 381/122; 84/726; 84/731

(57) ABSTRACT

Transferring digital data to a musical signal processor by a method comprising establishing a connection from a musical transducer to the musical signal processor, the musical transducer being of a type that converts a wireless type of signal into an electrical signal; exposing the musical transducer to a wireless data signal comprising the digital data, whereby the wireless data signal is converted into an electrical data signal by the musical transducer; and receiving and decoding the electrical data signal at the musical signal input of the musical signal processor. According to a preferred embodiment of the invention the musical transducer is a guitar pickup, the musical signal processor is a guitar pedal or other guitar signal processor, and the wireless data signal is a magnetic signal established by an electro-dynamic speaker of a smartphone or the like.

### CROSS REFERENCE TO RELATED APPLICATION

This application is related to and claims the benefit of U.S. provisional application Ser. No. 61/529,616 filed on 31 Aug. 2011, the contents of which are herein incorporated by reference in their entirety.

### FIELD OF THE INVENTION

The present invention relates to the programming of musical signal processors, e.g. guitar pedals.

### BACKGROUND OF THE INVENTION

Many modern musical signal processors, e.g. guitar pedals, include electronic hardware that hosts digital signal processing and/or digitally controlled signal processing. Both enable preset functionality and remote control of the different audio effects found in the pedal.

Often parameters, parameter presets, effects, processing algorithms, etc., are software implemented and programmable, as is also often the case with the entire firmware. Hence, many modern guitar pedals and other musical signal processors can be controlled, programmed and/or upgraded by establishing a data connection with a computer or data storage. Typically such connection is implemented by means of the popular USB interface which requires a cable connection to, e.g., a laptop computer for transferring new presets, firmware, etc., or other expensive and high technology communication forms such as Bluetooth, WiFi, Ethernet, RS-232, Firewire (1394), etc.

### SUMMARY OF THE INVENTION

An object of the present invention is to simplify and facilitate the programming of musical signal processors, e.g. guitar pedals or other guitar effect processors, vocal effect processors, etc., by providing an alternative to the usual requirement for a laptop computer and a USB cable.

The present invention relates to a method transferring digital data to a musical signal processor, the method comprising the steps of
establishing a connection from a musical transducer to a musical signal input of the musical signal processor, the musical transducer being of a type that converts a wireless type of signal into an electrical signal,
exposing the musical transducer to a wireless data signal comprising said digital data, whereby the wireless data signal is converted into an electrical data signal by the musical transducer,
receiving the electrical data signal at the musical signal input of the musical signal processor,
decoding the electrical data signal into said digital data.

By the present invention is provided a simple way to transfer digital data to a musical signal processor through a musical transducer connected to the musical signal processor, i.e. without the need of a USB connection.

In other words, the invention is about using existing communication channels which are available but not immediately intended for updating or changing the behavior of a signal processing device. Thereby additional, dedicated communication channels and related hardware is made optional. As an example, in one embodiment of the invention a smartphone is used to connect to some online or local service to obtain digital data, e.g. a firmware upgrade or a set of parameter presets, which is interpreted and communicated via some commutation channel already available between smartphone/transmitter and signal processing device. In the case of the musical signal processor being a guitar pedal, the existing commutation channel already available may e.g. comprise a magnetic transducer of the electric guitar, the normal guitar cable, and the musical signal input of guitar pedal.

According to the present invention the musical signal processor may be any kind of processor that operates on musical signals, e.g. a guitar pedal, guitar effects processor, vocal effects processor, amplifier, mixer, etc., and the digital data may be any kind of data usable by such musical signal processor, e.g. change of settings, parameter presets, effect plugins, firmware upgrade, etc. It should be mentioned that wherever the word guitar is used in the present specification it involves all kinds of guitars, including e.g. bass guitars and guitars with any number of strings.

The musical transducer may according to the present invention comprise any kind of transducer used in musical instruments or music production for establishing an electrical signal from any energy type. Embodiments may within the scope of the present invention thus make use of e.g. magnetic to electric transducers such as single-coil or humbucker magnetic pickups for electric guitars, acoustic to electric transducers such as microphones of any type for vocals and acoustic instruments, vibration to electric transducers, e.g. piezoelectric transducers, for acoustic instruments, etc. In an embodiment of the invention, the musical transducer, e.g. a microphone, may be a part of the musical signal processor unit and thus be electrically connected internally.

The connection from the musical transducer to the musical signal input of the musical signal processor may according to the present invention comprise any electric connection, preferably the type of connection that is normally used with the specific combination of musical transducer and musical signal processor, e.g. a single channel guitar cable with jack plugs/TS connectors in both ends for the connection between a typical electric guitar and a guitar effects pedal, or a 3-wire cable with XLR connectors in both ends for the connection between a high quality microphone and a vocal effects processor or mixer.

It is noted that also connections where the electrical signal is converted to something else on its way and then converted back to an electrical signal which is processed by the musical signal processor, e.g. as applied with wireless microphones, wireless guitar transmitters or other wireless instrument systems, as well as optical connections e.g. TOSLINK, are within the scope of the present invention, as the microphone or other musical transducer in such a setup still converts the wireless data signal to an electrical data signal which is delivered to the musical signal processor. The fact that the electrical data signal undergoes a conversion to e.g. a radio signal or optical signal and then back to an electrical signal again on its way is immaterial for the application of the invention.

The wireless data signal may according to the present invention comprise any data signal suitable for use with the particular musical transducer. For example an acoustic signal e.g. provided by a speaker of any kind, may be used as the wireless data signal in an embodiment where the musical transducer comprises a microphone. For use with an electric guitar where the musical transducer typically comprises a magnetic pickup, the wireless data signal according to the present invention preferably comprises a magnetic data signal, which can e.g. be generated by an electro-dynamic loudspeaker, i.e. a moving-coil loudspeaker. An example of a wireless data signal suitable for use with a piezoelectric transducer is a vibration signal e.g. generated by means of a cell phone or smart phone vibrator, or by means of rendering an audio signal through a speaker and using the vibrational effect thereof.

That the digital data may be transferred to the electrical system wirelessly simply by means of a e.g. a loudspeaker is a very advantageous feature of the present invention as it enables extremely common devices such as cell phones or smart phones to be used for transferring the digital data to the electrical system. Making use of such devices moreover inherently provides a means for obtaining the digital data in the first place, as most of such devices today have Internet connection or have access to other types of networks where the relevant digital data may be stored and obtained from.

Any way of comprising the digital data in the wireless data signal in such a way that the digital data are converted with the wireless signal into the electrical signal is within the scope of the present invention. In a preferred embodiment of the present invention is used a frequency-shift keying modulation technique, but several other modulation techniques or encoding schemes can be used as well, for example spread spectrum modulation, dual tone multi-frequency, amplitude- or phase-shift keying, frequency modulation, amplitude modulation, phase modulation, or any combination of these, etc.

According to the present invention the electrical signal comprising the digital data is received at the musical signal input of the musical signal processor, i.e. at the input where the musical signal processor normally receives the musical signal that it processes and usually forwards to downstream equipment, e.g. a mixer, amplifier, loudspeakers, etc. This is a significant advantage of the present invention, as it makes it possible to avoid additional hardware for dedicated communication interfaces such as USB connectivity in the musical signal processor, thereby making it an option for the manufacturer instead of a requirement. The present invention enables a musical signal processor such as e.g. a guitar pedal to benefit from firmware upgrades and bulk changes such as parameter presets using only the normal audio signal cable and input of the musical signal processor.

In a preferred embodiment of the present invention the digital data comprise guitar pedal parameter presets created by well-known guitarists, e.g. for the TC Electronic® TonePrint-enabled guitar pedals.

In an advantageous embodiment of the present invention the wireless data signal is established by a handheld device, which may be any kind of mobile device, e.g. personal digital assistant PDA, smartphone, cell phone, tablet computer, handheld game console, portable media player, etc.

In preferred embodiments the handheld device comprises network or Internet connectivity, and the method according to the present invention comprises a step of obtaining the digital data from the network or the Internet. Combining an online storage for digital data for use in musical signal processors with mobile Internet-enabled devices such as smartphones which have become extremely common, and providing the present invention for transferring the digital data from the mobile device to the musical signal processor in a convenient and simple way makes a very advantageous and usable feature.

According to an advantageous embodiment of the present invention, an indicator of any kind at the musical signal processor is used to signal some extent of status information thus establishing a feedback. The indicator may e.g. be a light emitting diode LED, a display, a sound emitter, etc., which according to an embodiment of the present invention is used for signalling e.g. successful data transfer or the status thereof, or even failure or a request to resend the data. In an advanced embodiment the handheld device may comprise means to interpret the indication at the musical signal processor and thereby e.g. resend automatically when the musical signal processor requests so, i.e. without interaction by the user. Smartphones, for example, are usually equipped with both a microphone and a camera so the capturing of visible and/or audible feedback from the musical signal processor is inherently facilitated.

The present invention further relates to a musical signal processor comprising a musical signal input and a processor, wherein the processor is set up to monitor an electrical signal received at the musical signal input, and wherein the processor comprises a signal decoder for retrieving a digital signal comprised by said electrical signal.

The present invention further relates to a method for transferring digital data to a guitar signal processor, the method comprising the steps of:
establishing a connection between the guitar signal processor and an electric guitar comprising a magnetic pickup,
exposing the magnetic pickup to a magnetic data signal established by means of an electro-dynamic speaker, the magnetic data signal representing said digital data,
receiving at the guitar signal processor an electrical data signal established by said magnetic pickup in reaction to said magnetic data signal, and
decoding said electrical data signal into said digital data.

By the present invention is provided a simple and very convenient way to transfer digital data to a guitar signal processor through the electric guitar pickups connected to the guitar signal processor, i.e. without the need of a USB connection.

In other words, the invention is about using the existing guitar cable connection used for communication the music to the guitar signal processor to also be used for updating or changing the behavior of the guitar signal processing device. Thereby additional, dedicated communication channels and related hardware is made optional. As an example, in one very advantageous embodiment of the invention a smartphone is used to connect to some online or local service to obtain digital data, e.g. a firmware upgrade or a set of parameter presets, which is interpreted and communicated via the guitar pickup and guitar cable to the guitar signal processor.

It is noted that also connections between guitar and guitar signal processor where the electrical signal is converted to something else on its way and then converted back to an electrical signal which is processed by the guitar signal processor, e.g. as applied with wireless guitar transmitters, are within the scope of the present invention, as the magnetic pickups of the guitar in such a setup still converts the magnetic data signal to an electrical data signal which is delivered to the guitar signal processor. The fact that the electrical data signal undergoes a conversion to e.g. a radio signal and then back to an electrical signal again on its way is immaterial for the application of the invention.

According to the present invention the digital data may be any kind of data usable by such a guitar signal processor, e.g. change of settings, parameter presets, effect plugins, firmware upgrade, etc. It should be mentioned that wherever the word guitar is used in the present specification it involves all kinds of guitars, including e.g. bass guitars and guitars with any number of strings.

The magnetic transducer may according to the present invention comprise e.g. single-coil or humbucker magnetic pickups for electric guitars.

In an advantageous embodiment of the present invention the wireless data signal preferably comprises a magnetic data signal, which can e.g. be generated by an electro-dynamic loudspeaker, i.e. a moving-coil loudspeaker.

That the digital data may be transferred to the electrical system wirelessly simply by means of a e.g. a loudspeaker is a very advantageous feature of the present invention as it enables extremely common devices such as cell phones or smart phones to be used for transferring the digital data to the electrical system. Making use of such devices moreover inherently provides a means for obtaining the digital data in the first place, as most of such devices today have Internet connection or have access to other types of networks where the relevant digital data may be stored and obtained from.

Any way of comprising the digital data in the magnetic data signal in such a way that the digital data are converted with the magnetic signal into the electrical signal is within the scope of the present invention. In a preferred embodiment of the present invention is used a frequency-shift keying modulation technique, but several other modulation techniques or encoding schemes can be used as well, for example spread spectrum modulation, dual tone multi-frequency, amplitude- or phase-shift keying, frequency modulation, amplitude modulation, phase modulation, or any combination of these, etc.

According to the present invention the electrical signal comprising the digital data is received at the guitar signal input of the guitar signal processor, i.e. at the input where the guitar signal processor normally receives the guitar signal that it processes and usually forwards to downstream equipment, e.g. a mixer, amplifier, loudspeakers, etc. This is a significant advantage of the present invention, as it makes it possible to avoid additional hardware for dedicated communication interfaces such as USB connectivity in the guitar signal processor, thereby making it an option for the manufacturer instead of a requirement. The present invention enables a guitar signal processor such as e.g. a guitar pedal to benefit from firmware upgrades and bulk changes such as parameter presets using only the normal guitar cable and input of the guitar signal processor.

In a preferred embodiment of the present invention the digital data comprise guitar pedal parameter presets created by well-known guitarists, e.g. for the TC Electronic® TonePrint-enabled guitar pedals.

In an advantageous embodiment of the present invention the wireless data signal is established by a handheld device, which may be any kind of mobile device, e.g.

personal digital assistant PDA, smartphone, cell phone, tablet computer, handheld game console, portable media player, etc.

In preferred embodiments the handheld device comprises network or Internet connectivity, and the method according to the present invention comprises a step of obtaining the digital data from the network or the Internet.

According to the present invention an advantageous embodiment of the invention provides for obtaining prepared audio files including the digital data from a central storage, e.g. an Internet website. The audio files have been pre-processed in order to avoid the need of processing the digital data and modulating them at each user's smartphone. With this embodiment the user simply downloads a desired digital data, e.g. a new firmware or a desired TonePrint, and plays it by means of an audio playback functionality of the mobile device, e.g. his smartphone. When the audio file is rendered into an acoustic signal (audible or not) by the speaker of the mobile device, there is also generated a magnetic signal, provided the speaker is of the common electro-dynamic type, also called a moving coil speaker. Besides being simple and user-friendly as the user just has to download an audio file and play it back as he would with MP3 music, for example, this advantageous method further makes it fast and not very demanding of the particular mobile device.

In an alternative embodiment the handheld device, e.g. smartphone, is used for producing the modulated audio signal from downloaded parameters or other digital data. This may be advantageous for minimizing the download size, enabling the user to consider, confirm or tweak the parameters before they are transferred to the signal processor, and in order to make it possible for the handheld device or the user to choose or adjust the transfer method at the transfer time, e.g. if magnetic or acoustic transfer should be used, or if the modulation frequency band should be adjusted for a specific pickup type, etc. USB

In a preferred embodiment the guitar signal processor is comprised by a guitar pedal.

The present invention further relates to a guitar signal processor comprising a guitar signal input and a processor, wherein the processor is set up to monitor an electrical signal received at the guitar signal input, and wherein the processor comprises a signal decoder for retrieving a digital signal comprised by said electrical signal.

The present invention further relates to a method for transferring digital data to a musical signal processor, the method comprising the steps of:
establishing a connection between the musical signal processor and a microphone,
exposing the microphone to an acoustic data signal established by means of a speaker, the acoustic data signal representing said digital data,
receiving at the musical signal processor an electrical data signal established by said microphone in reaction to said acoustic data signal, and
decoding said electrical data signal into said digital data.

By the present invention is provided a simple way to transfer digital data to a musical signal processor through a microphone connected to the musical signal processor, i.e. without the need of a USB connection. The microphone may be any microphone, including singer/vocal microphone, external or integrated instrument microphone of any kind, etc.

In other words, the invention is about using the existing communication channel between a microphone and the downstream processing equipment even though that communication channel was not designed for or intended for updating or changing the behavior of a signal processing device. Thereby additional, dedicated communication channels and related hardware is made optional. As an example, in one embodiment of the invention a smartphone is used to connect to some online or local service to obtain digital data, e.g. a firmware upgrade or a set of parameter presets, which is interpreted and communicated via the microphone and microphone cable already available between smartphone/transmitter and signal processing device.

According to the present invention the musical signal processor may be any kind of processor that operates on microphone signals, e.g. a guitar pedal or guitar effects processor for instrument microphones or a vocal effects processor or a mixer for vocal microphones, etc., and the digital data may be any kind of data usable by such musical signal processor, e.g. change of settings, parameter presets, effect plugins, firmware upgrade, etc.

The connection from the microphone to the musical signal processor may according to the present invention comprise any suitable electrical connection, e.g. a 3-wire cable with XLR connectors in both ends for balanced microphones with or without phantom power, or a common 2-wire cable with jack plugs/TS connectors in both ends for less expensive consumer microphones. In an embodiment of the invention, the microphone may be a part of the musical signal processor unit and thus be electrically connected internally.

It is noted that also connections where the electrical signal is converted to something else on its way and then converted back to an electrical signal which is processed by the musical signal processor, e.g. as applied with wireless microphones, are within the scope of the present invention, as the microphone in such a setup still converts the acoustic data signal to an electrical data signal which is delivered to the musical signal processor. The fact that the electrical data signal undergoes a conversion to e.g. a radio signal and then back to an electrical signal again on its way is immaterial for the application of the invention.

That the digital data may be transferred to the electrical system wirelessly simply by means of a speaker is a very advantageous feature of the present invention as it enables extremely common devices such as cell phones or smartphones to be used for transferring the digital data to the electrical system. Making use of such devices moreover inherently provides a means for obtaining the digital data in the first place, as most of such devices today have Internet connection or have access to other types of networks where the relevant digital data may be stored and obtained from.

Any way of comprising the digital data in the acoustic data signal in such a way that the digital data are converted with the acoustic signal into the electrical signal is within the scope of the present invention. In a preferred embodiment of the present invention is used a frequency-shift keying modulation technique, but several other modulation techniques or encoding schemes can be used as well, for example spread spectrum modulation, dual tone multi-frequency, amplitude- or phase-shift keying, frequency modulation, amplitude modulation, phase modulation, or any combination of these, etc.

According to the present invention the electrical signal comprising the digital data is received at the musical signal input of the musical signal processor, i.e. at the input where the musical signal processor normally receives a microphone or instrument signal. This is a significant advantage of the present invention, as it makes it possible to avoid additional hardware for dedicated communication interfaces such as USB connectivity in the musical signal processor, thereby making it an option for the manufacturer instead of a requirement. The present invention enables a musical signal processor such as e.g. a vocal effects processor to benefit from firmware upgrades and bulk changes such as parameter presets using only the normal audio signal cable and input of the musical signal processor.

In an advantageous embodiment of the present invention the acoustic data signal is established by a handheld device, which may be any kind of mobile device, e.g. personal digital assistant PDA, smartphone, cell phone, tablet computer, handheld game console, portable media player, etc.

In preferred embodiments the handheld device comprises network or Internet connectivity, and the method according to the present invention comprises a step of obtaining the digital data from the network or the Internet. Combining an online storage for digital data for use in musical signal processors with mobile Internet-enabled devices such as smartphones which have become extremely common, and providing the present invention for transferring the digital data from the mobile device to the musical signal processor in a convenient and simple way makes a very advantageous and usable feature.

According to the present invention an advantageous embodiment of the invention provides for obtaining prepared audio files including the digital data from a central storage, e.g. an Internet website. The audio files have been pre-processed in order to avoid the need of processing the digital data and modulating them at each user's smartphone. With this embodiment the user simply downloads a desired digital data, e.g. a new firmware or a desired parameter preset package, and plays it by means of an audio playback functionality of the mobile device, e.g. his smartphone. Thereby the audio file including the digital data is rendered into an acoustic signal (audible or not) by the speaker of the mobile device, and this signal can be picked up by a microphone. Besides being simple and user-friendly as the user just has to download an audio file and play it back as he would with MP3 music, for example, this advantageous method further makes it fast and not very demanding of the particular mobile device.

The present invention further relates to a musical signal processor comprising a microphone signal input and a processor, wherein the processor is set up to monitor an electrical signal received at the microphone signal input, and wherein the processor comprises a signal decoder for retrieving a digital signal comprised by said electrical signal.

### THE DRAWINGS

The invention will in the following be described with reference to the drawings where

FIG. 1 illustrates data transfer according to prior art,

FIG. 2 illustrates an embodiment of the present invention for use with guitars,

FIG. 3 illustrates an embodiment of the present invention more generically,

FIG. 4 illustrates an embodiment of the present invention for use with microphones,

FIG. 5 illustrates an embodiment of the present invention in more detail,

FIG. 6 illustrates a test setup,

FIG. 7 illustrates a test result,

FIG. 8 illustrates an example of an FSK signal,

FIG. 9 illustrates an FSK demodulation process,

FIG. 10 illustrates a detail related to FSK modulation,

FIG. 11 illustrates signal established during FSK demodulation, and

FIG. 12 illustrates a clock recovery circuit suitable for use with an embodiment of the present invention.

### DETAILED DESCRIPTION

Many modern guitar signal processors (e.g. guitar pedals) includes electronic hardware that host digital signal processing and/or digital controlled signal processing. Both enable preset functionality and remote control of the different audio effects found in the pedal, as well as possibilities to upgrade the firmware or plugins.

For example, TC Electronic® recently presented a new concept called TonePrint. This concept is a kind of a preset where a meta control layer, between user interface controls and audio signal processing, controls the behavior of the guitar pedal. The meta control layer is tuned by experts such as guitar player stars. The TonePrints are available for download from a website, and so far TC Electronic® guitar pedals with Toneprint capability have to be connected to a computer with a USB cable for new Toneprints to be downloaded to the pedals.

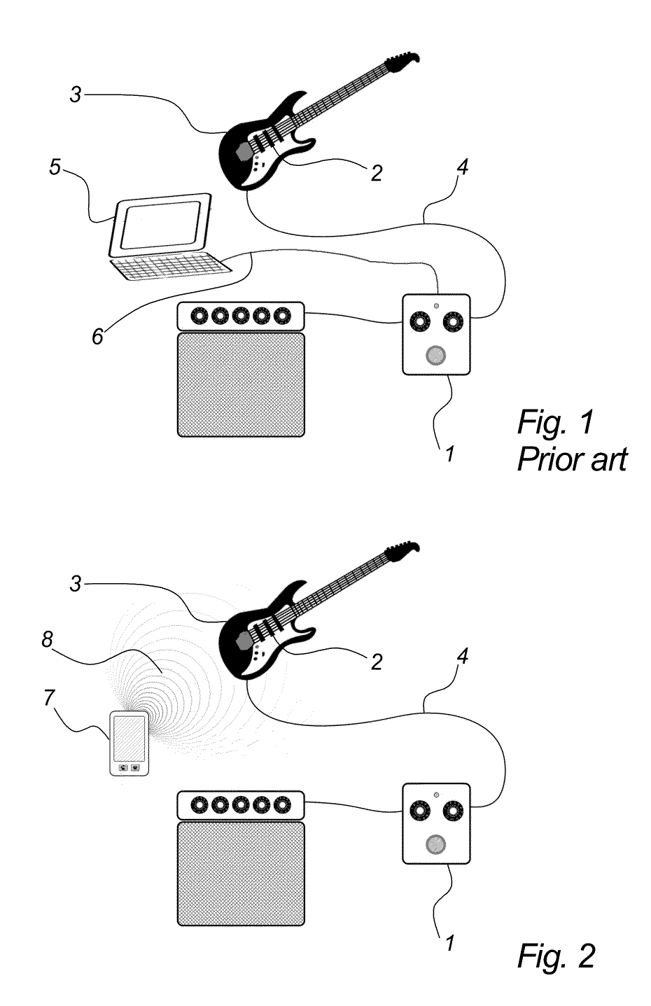

A similar setup is illustrated in FIG. 1, which illustrates prior art data transfer to guitar pedals 1 or other musical signal processors. A guitar 3 with a magnetic pickup system 2 is connected to the guitar pedal 1 by a guitar cable 4. A laptop computer 5 is also connected to the guitar pedal 1 by means of a USB cable 6. The two connections do not need to be established at the same time as shown in FIG. 1, but all the hardware for both communication types (guitar signal and USB) has to be present for the connections to be made.

According to the present invention is provided an alternative and very advantageous way of communicating data to the guitar pedal or any other musical signal processor.

FIG. 2 illustrates an embodiment of the present invention for use with guitars, i.e. for transferring data to guitar pedals, guitar effects processors, amplifiers, mixers, etc. Comparing with the embodiment of FIG. 1, the embodiment of FIG. 2 comprises the guitar pedal 1, the guitar 3 with a magnetic pickup 2 and the guitar cable 4 connecting the pickups with the guitar signal processor. However, instead of connection a laptop computer 5 or the like to the guitar signal processor by a USB connection, the embodiment of FIG. 2 comprises a smartphone 7 which establishes a wireless, magnetic data signal 8 which can be picked up by the magnetic pickup 2 of the guitar 3.

In the embodiment of FIG. 2 a mobile phone is used as data transmitter, e.g. for transmitting the above-mentioned TonePrints. Any mobile device which has the capability to play back audio can be used, as long as the device is equipped with an electro-dynamic speaker, since the signal travels via the magnetic coupling from the speaker to the guitar pickup—and not primarily through the acoustic (audible) path. A mobile device with a piezoelectric transducer as audio playback object will not establish a usable data channel for use with magnetic transducers, at least. However, if the speaker unit of the mobile device does not create a suitable magnetic signal it is almost always possible to connect a set of earplugs or headphones with electrodynamic speakers to the mobile device, thus making it compatible with the present invention anyway.

However, many modern mobile devices today has electro-dynamic speakers, including but not limited to: iPhone 3G, iPhone 3Gs, iPhone 4, iPod Touch 4, HTC WildFire, HTC Desire, Sony Ericsson Expire, etc.

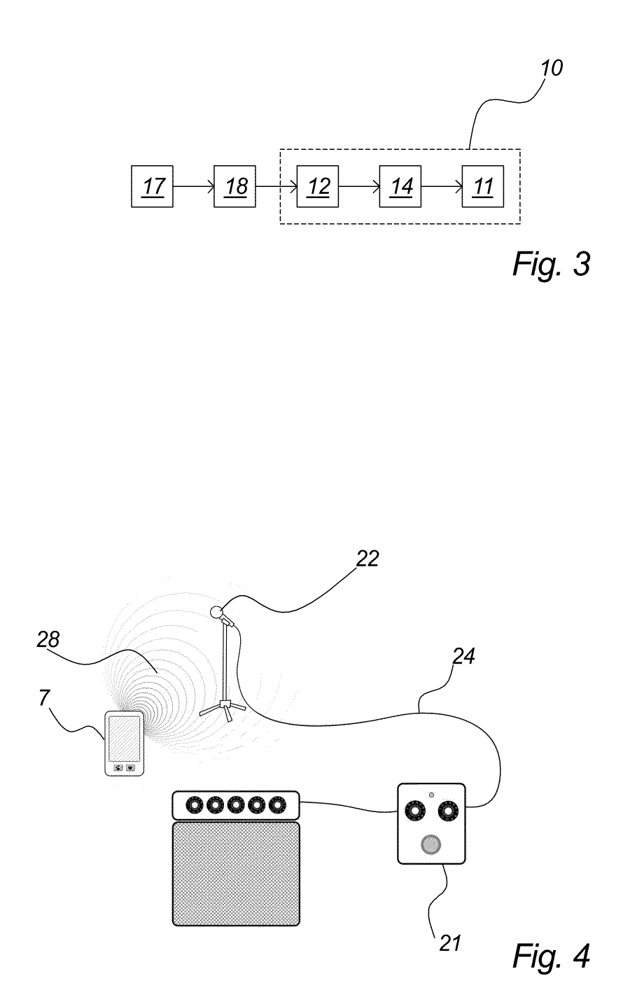

FIG. 3 illustrates more generally an application of the present invention. A typical music generation chain 10 comprises a musical transducer 12, an electrical connection 14 and a musical signal processor 11. When digital data are to be transferred to the musical signal processor a wireless data signal 18 is established by means of any suitable device, e.g. a smartphone 17. Other than selecting a wireless data signal 18 type compatible with the musical transducer 12, the rest of the data transfer process and possibilities within the scope of the present invention corresponds mainly to the guitar setup illustrated above with reference to FIG. 2, and hence the guitar setup will be used as the general example in most of the following, even though several other setups with musical transducers and musical signal processors are advantageous and within the scope of the present invention.

FIG. 4 illustrates yet another particular embodiment of the present invention. A microphone 22 is connected by cable 24 to a musical signal processor, e.g. a vocal effects processor in the case of a singer's microphone, or e.g. a guitar pedal or other instrument processor in the case that the microphone is an instrument microphone. A smartphone 7 or other handheld device with audio playback capabilities is used to establish an acoustic data signal 28 comprising the digital data, which may be picked up by the microphone and then processed by the musical signal processor 21.

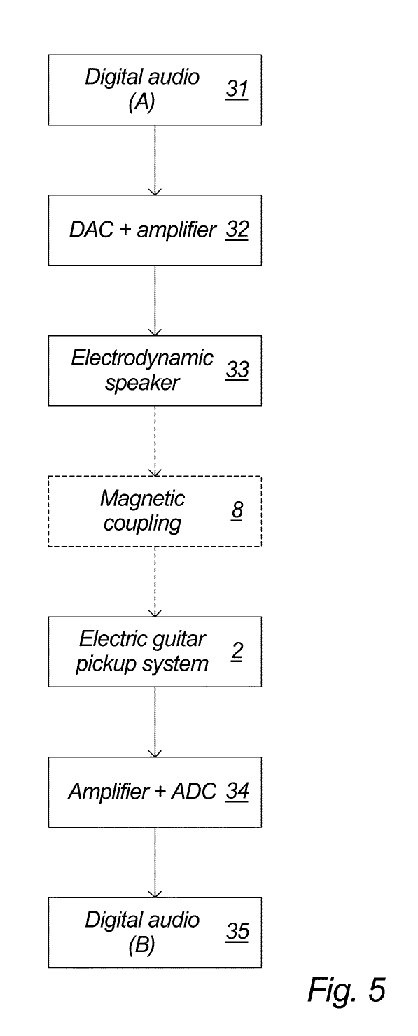

With reference to FIG. 5, the digital data package, e.g. a TonePrint or a firmware, is modulated, e.g. by Frequency Shift Keying, and the digital data 31 are then sent through a data channel which in the guitar embodiment consists of:
Digital to analog converter DAC+speaker amplifier (mobile device) 32
Electrodynamic speaker (mobile device) 33
Magnetic coupling from speaker to guitar pickup 8
Guitar pickup system (magnet field to electric voltage) 2
Input amplifier+analog to digital converter ADC (guitar pedal) 34.

Once the data package 35 is received and verified, the preset, Toneprint, firmware or any other kind of data structure can be used in the pedal to change the behavior of the pedal or as software update.

In preferred embodiments of the present invention the musical signal processor, e.g. guitar pedal, comprises update detection analysis which monitors the incoming audio signal to detect if and when it comprises modulated digital data according to the invention. Apart from knowing when to start demodulating digital data, this update detection analysis can be used for e.g. muting the signal processing system or output signal during the update or for putting the signal processor into some special tweak mode.

As an alternative to automatic update detection, a further embodiment of the present invention uses the user interface of the musical signal processor, e.g. a multi position knob or a dedicated switch or button to enable the user to put the musical signal processor into some special mode which enables the data transfer of the present invention. As with the automatic discovery mentioned above, the manual method may still further cause e.g. the processor output to be muted while digital data are received.

As explained above, the musical signal processor, e.g. guitar pedal, may comprise update user interface interaction, i.e. making use of e.g. existing leds or display to establish a kind of pseudo 2-way communication—either via the user or directly by utilizing the microphone or camera built in to most mobile devices.

Compared to the entire signal chain, the DAC and speaker amplifier 32 will have a near-flat frequency response, but the electrodynamic speaker 33 will act like a high-pass filter with roll-off located in the range 100-400 Hz. The weakest and most unpredictable link in the signal chain is the magnetic coupling 8 from speaker 33 to guitar pickup 2. Measurements have shown that this link will act as a band-pass filter located in the region 1 kHz to 10 kHz. The guitar pickup system 2 level and tone controls will of course affect the transfer function, so it is preferred that these controls are “fully open”, i.e. set so that they influence the signal as little as possible. When this is the case, the rest of the channel will be quite frequency-flat in the audio band.

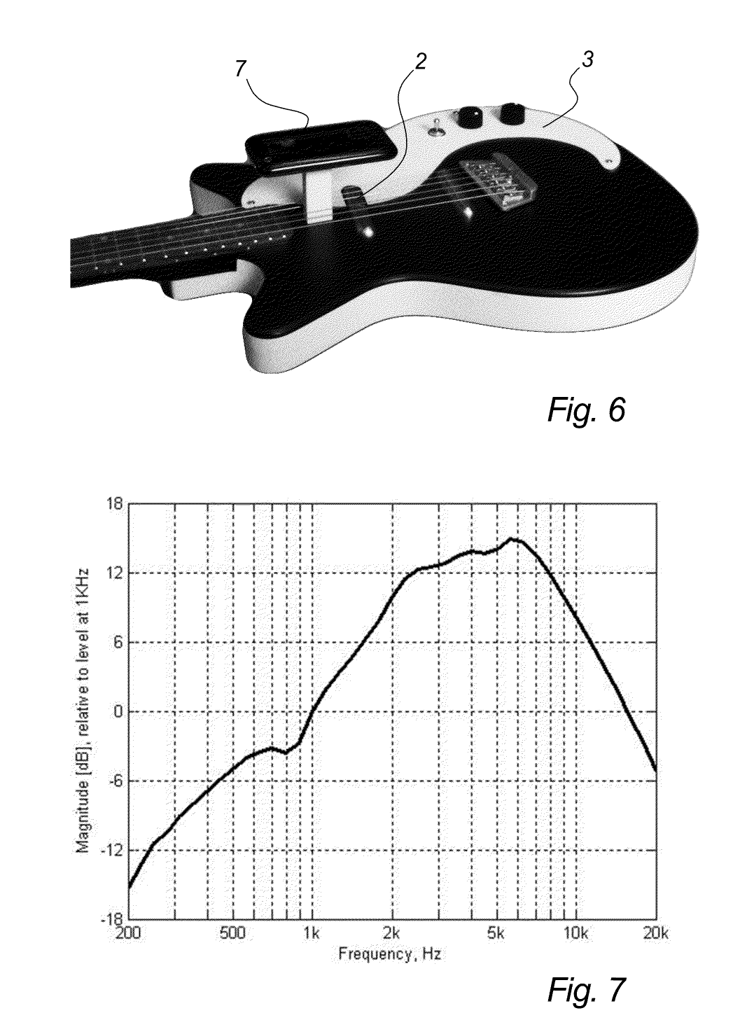

A lot of things influences the behavior of the link: mobile device speaker, position of mobile device relative to the guitar, guitar pickup system and guitar pickup system level/tone control settings. Experimentation has shown that the best coupling between mobile device 7 and pickup 2 of the guitar 3 seems to be when the two items are located on two parallel horizontal planes as shown by the test setup of FIG. 6. It is noted that the support for the mobile device 7 shown in FIG. 6 is not a requirement for carrying out the invention, but is simply used when experimenting and documenting the results in order to ensure consistent and well-defined physical circumstances for the experiments.

With the test setup shown in FIG. 6 an experiment has been carried out where a magnitude response (as function of frequency) from an iPhone 3GS to a “lipstick” single-coil pickup (“Danelectro”) has been measured.

Measurement setup:
Multi-tone audio track playback from mobile device (6 frequencies per octave).
Device located as shown in FIG. 6.
Guitar controls fully open, i.e. as little influence on the signal as possible.
Guitar output signal connected to high impedance professional computer interface (analog-to-digital converter ADC)

The recorded signal was analyzed offline—and the level of each tone in the signal represents a point in the resulting magnitude response graph as shown in FIG. 7. The magnitudes shown in the graph are relative gain with respect to the gain at 1 kHz, thus making the graph cross 0 dB at 1 kHz.

From the experiment and the resulting magnitude response in FIG. 7 it is clear that the magnetic coupling part of the data transfer method of the present invention is feasible, as the magnitude response shows a frequency band where a reasonable signal-noise-ratio SNR can be expected, e.g. in the band between 2 kHz and 8 kHz in this specific setup, i.e. for this specific combination of phone, pickup and physical locations. Maximizing the SNR is beneficial as it reduces the risk of bit errors, i.e. higher SNR leads to lower bit-error-rate BER. A modulation of the wireless signal in this band can thus be expected to be a good way of transferring data from the mobile device to the magnetic pickup. If frequency-shift keying is used as modulation type, the two frequencies for encoding 0 and 1, respectively, could for example be chosen as 4 kHz and 6 kHz.

Regarding the modulation the wireless signal, e.g. magnetic signal, and the consequent electrical signal created by the transducer, e.g. pickup, in order to transfer the digital data, any suitable technique can be used within the scope of the present invention, as long as the modulation type supports that the data in the modulated signal live through first a conversion into a wireless energy form, and then a conversion into electrical form. One of the simplest modem (modulation and demodulation) techniques used for digital data transfer is FSK (frequency shift keying). Different subtypes of FSK exist, but in a simple form, the modulation output signal consists of a tone with a frequency that shifts between two values dependent on the input binary data, i.e. the digital data. The simple principle of FSK also makes it practical for use with multiple subsequent conversions of energy types.

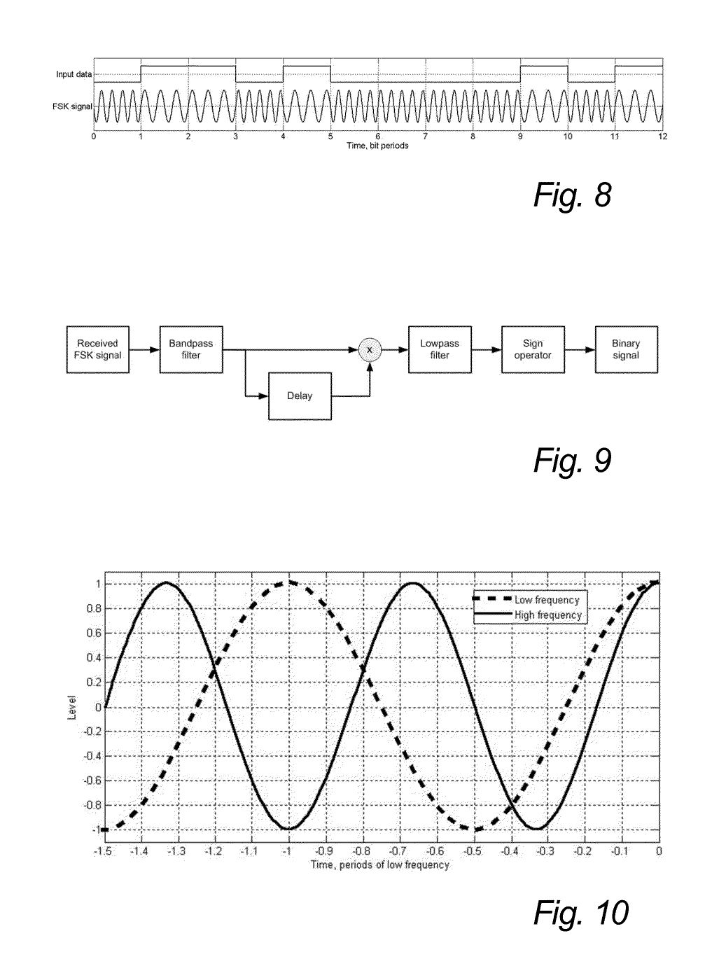

An example of an FSK signal is shown in FIG. 8. In this example the FSK signal has continuous phase and each bit is represented with an integer number of sinusoidal half-waves. The input data represent the digital data to be transferred to the musical signal processor, and the FSK signal represents the physical signal actually transmitted. It is noted that the choice of using an integer number of half-waves per bit is not a requirement for the invention; in principle any signal length can be defined as representing a bit period.

The demodulation process to be carried out in the musical signal processor can be solved in different ways. In other FSK applications often two band-pass filters with center frequencies equal to the two FSK tones are used. The relation of band-pass filter levels are then used to decide whether a high or low frequency tone is received—corresponding to a “0” or a “1”. This technique is however quite sensitive to the frequency response of the data channel, which in this application is quite unpredictable as it depends on the particular mobile device used, the particular pickup system used, how the devices are arranged with respect to each other, etc.

Hence, another simple demodulator comprising the structure shown in FIG. 9 is suggested for use with an embodiment of the present invention. First the received FSK signal passes a band-pass filter, which attenuates noise and distortion components. En estimate of the autocorrelation (for a given lag) of the signal is then found using a delay and low-pass filter.

Finally the signal is converted to binary levels using a sign operator. This topology does not suffer from the same level sensitivity as the “dual band-pass filter” described above.

To maximize the performance of the demodulator, an optimal relation between FSK frequencies and delay value must be found. An example of such an optimal relation is shown in FIG. 10. In this figure two sinusoidals are shown, having a frequency ratio of 1.5. If the delay in the demodulator equals the duration of a low frequency cycle, the multiplier peak output value will equal +1.0 when a low frequency tone (dashed line) is entered and −1.0 when a high frequency tone (solid line) is entered (assuming normalized input level). Another sensible delay value would be 60% of the low frequency cycle duration. Using this delay value, the modulator peak output will be approximately −0.8 and +0.8 for low and high frequency input respectively.

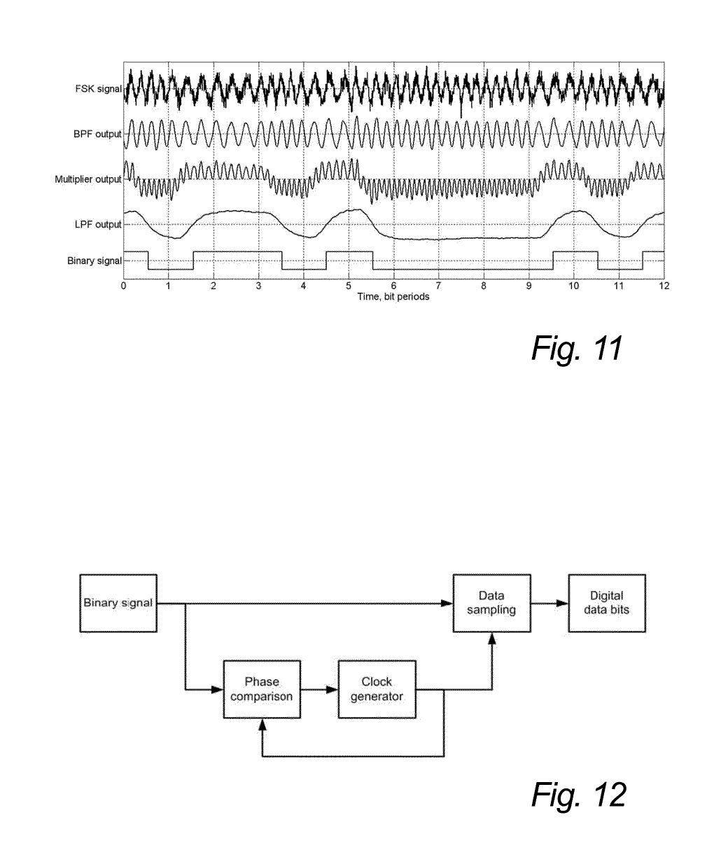

An example of input, intermediate and output signals of a demodulator according to an embodiment of the present invention is shown in FIG. 11. The FSK input signal in FIG. 11 equals the FSK signal found in FIG. 8, just with noise added for improved realism.

Once the binary signal is found, a clock signal has to be established to sample the data at right points in time. To solve that task, the clock signal has to be synchronous with the binary data. The clock recovery process can be solved in many ways known by the skilled person. Most “blind” receivers use a system similar to the one shown in FIG. 12, which works well in an embodiment of the present invention.

This system has a phase locking mechanism that ensures the transitions of the binary signal and the transitions of the clock signal ends up being aligned. The sample process samples the data 50% inside a bit period to ensure that the signal is valid before sampling.

1. A method for transferring digital data to a musical signal processor, the method comprising the steps of
establishing a connection from a musical transducer to a musical signal input of the musical signal processor, the musical transducer being of a type that converts a wireless type of signal into an electrical signal,
exposing the musical transducer to a wireless data signal comprising said digital data, whereby the wireless data signal is converted into an electrical data signal by the musical transducer,
receiving the electrical data signal at the musical signal input of the musical signal processor, and
decoding the electrical data signal into said digital data.

2. A method according to claim 1, wherein said wireless data signal is established by a handheld device.

3. A method according to claim 2, wherein said handheld device comprises network or Internet connectivity, and wherein said method comprises a step of obtaining said digital data from said network or the Internet.

4. A method according to claim 1, wherein said electrical data signal is modulated by frequency shift keying.

5. A method according to claim 1, wherein said musical transducer comprises a magnetic pickup and said wireless data signal comprises a magnetic data signal; and wherein said exposing the musical transducer to a wireless data signal comprises establishing a magnetic data signal comprising the digital data by rendering an audio signal comprising the digital data through an electro-dynamic speaker.

6. A method according to claim 5, wherein said electro-dynamic speaker is comprised by a handheld device and said magnetic pickup is comprised by an electric guitar.

7. A method according to claim 6, wherein said audio signal comprising the digital data is obtained from said network or the Internet by said handheld device.

8. A method according to claim 6, wherein said musical signal processor is comprised by a guitar pedal.

9. A method according to claim 1, wherein said musical transducer comprises a microphone and said wireless data signal comprises an acoustic data signal; and wherein said exposing the musical transducer to a wireless data signal comprises establishing an acoustic data signal comprising the digital data by rendering an audio signal comprising the digital data through a speaker.

10. A method according to claim 9, wherein said speaker is comprised by a handheld device.

11. A method according to claim 10, wherein said audio signal comprising the digital data is obtained from said network or the Internet by said handheld device.

12. A method according to claim 1, wherein said musical transducer comprises a piezoelectric sensor and said wireless data signal comprises a vibrational data signal; and wherein said exposing the musical transducer to a wireless data signal comprises establishing a vibrational data signal comprising the digital data by means of a handheld device.

13. A method according to claim 1, wherein the method comprises a step of establishing at said musical signal processor an indication of status or confirmation upon the decoding of said digital data.

14. A musical signal processor comprising a musical signal input and a processor, wherein the processor is set up to monitor an electrical signal received at the musical signal input, and wherein the processor comprises a signal decoder for retrieving a digital signal comprised by said electrical signal.

15. A method for transferring digital data to a guitar signal processor, the method comprising the steps of:
establishing a connection between the guitar signal processor and an electric guitar comprising a magnetic pickup,
exposing the magnetic pickup to a magnetic data signal established by means of an electro-dynamic speaker, the magnetic data signal representing said digital data,
receiving at the guitar signal processor an electrical data signal established by said magnetic pickup in reaction to said magnetic data signal, and
decoding said electrical data signal into said digital data.

16. A method according to claim 15, wherein said electro-dynamic speaker is comprised by a handheld device and wherein the method comprises utilizing an audio playback functionality of said handheld device to render an audio signal comprising said digital data through the electro-dynamic speaker to establish said magnetic data signal.

17. A method according to claim 16, wherein said handheld device comprises network or Internet connectivity, and wherein said method comprises a step of obtaining said digital data from said network or the Internet.

18. A method according to claim 17, wherein said obtaining said digital data from said network or the Internet comprises obtaining an audio signal comprising said digital data.

19. A method according to claim 15, wherein said electrical data signal is modulated by frequency shift keying.

20. A method according to claim 15, wherein said guitar signal processor is comprised by a guitar pedal.

21. A guitar signal processor comprising a guitar signal input and a processor, wherein the processor is set up to monitor an electrical signal received at the guitar signal input, and wherein the processor comprises a signal decoder for retrieving a digital signal comprised by said electrical signal.

22. A method for transferring digital data to a musical signal processor, the method comprising the steps of:
establishing a connection between the musical signal processor and a microphone,
exposing the microphone to an acoustic data signal established by means of a speaker, the acoustic data signal representing said digital data,
receiving at the musical signal processor an electrical data signal established by said microphone in reaction to said acoustic data signal, and
decoding said electrical data signal into said digital data.

23. A method according to claim 22, wherein said speaker is comprised by a handheld device and wherein the method comprises utilizing an audio playback functionality of said handheld device to render an audio signal comprising said digital data through the speaker to establish said acoustic data signal.

24. A method according to claim 23, wherein said handheld device comprises network or Internet connectivity, and wherein said method comprises a step of obtaining said digital data from said network or the Internet.

25. A method according to claim 24, wherein said obtaining said digital data from said network or the Internet comprises obtaining an audio signal comprising said digital data.

26. A method according to claim 22, wherein said electrical data signal is modulated by frequency shift keying.

27. A musical signal processor comprising a microphone signal input and a processor, wherein the processor is set up to monitor an electrical signal received at the microphone signal input, and wherein the processor comprises a signal decoder for retrieving a digital signal comprised by said electrical signal.
